(19) United States
(12) Patent Application Publication
(10) Pub. No.: US 2025/0291775 A1
(43) Pub. Date: Sep. 18, 2025

(54) Data Processing Method and Data Processing System

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Chuo-Jui Wu, Taipei (TW); Yu-Chi Liao, Taipei (TW)

(73) Assignees: Inventec (Pudong) Technology Corp., Shanghai (CN); Inventec Corporation, Taipei (TW)

(21) Appl. No.: 18/658,978

(22) Filed: May 8, 2024

(30) Foreign Application Priority Data
Mar. 14, 2024 (CN) 202410295456.9

(51) Int. Cl. G06F 16/215; G06F 16/28

(52) U.S. Cl. CPC G06F 16/215; G06F 16/285

(57) ABSTRACT

A data processing method is provided. The data processing method includes clustering a data set using a clustering method to generate a plurality of data groups, wherein the data set includes a plurality of data points; selecting data groups with the fewest number of data points among the plurality of data groups; for each data group with the fewest number of data points, determining a local most possible outlier of the data group; and determining a most possible outlier from the local most possible outliers of the data groups with the fewest number of data points according to a center of a data body.

### BACKGROUND OF THE INVENTION

### 1. Field of the Invention

The present invention relates to a data processing method and a data processing system, and more particularly, to a data processing method and a data processing system capable of determining most possible outliers.

### 2. Description of the Prior Art

Data sets are prone to contain noisy data. Noisy data is data with additional meaningless information or information capable of misleading data analysis in the data set. In order to get more accurate data analysis results, data pre-processing must be performed to remove the data with additional meaningless information and correct the data with information capable of misleading data analysis before data analysis, to improve the quality and reliability of data analysis results. Outliers are one type of noisy data. Conventional outlier detection method is to use statistical P-values to identify outliers in the data set. An allowable p-value (or significance level) may be given to find the boundary value corresponding to the p-value. As such, the outlier would be identified based on the boundary value. However, the conventional outlier detection method can only determine the maximum or minimum value in the data set as outliers. As a result, the conventional outlier detection method is not applicable in many digital application projects. For example, a data value “1” of current signal represents the power-on state, and a value data “0” represents the power-off state. Due to external interference, the data value determined based on received signals may be between 0 and 1. Under such a situation, the data value determined based on the received signal with unwanted noise may be between 0 and 1. But, since the data values 0 and 1 are extreme values in the data set, the correct data values 0 and 1 would be determined as outliers instead. In short, the conventional outlier detection method may easily identify incorrect outliers. Thus, there is a need for improvement.

### SUMMARY OF THE INVENTION

It is therefore a primary objective of the present invention to provide a data processing method and a data processing system capable of determining most possible outliers, in order to resolve the aforementioned problems.

The present invention discloses a data processing method, comprising: clustering a data set to generate a plurality of data groups by using a clustering method, wherein the data set comprises a plurality of data points; selecting data groups with the fewest number of data points among the plurality of data groups; for each data group with the fewest number of data points, determining a local most possible outlier of the data group; and determining a most possible outlier from the local most possible outliers of the data groups with the fewest number of data points according to a center of a data body.

The present invention further discloses a data processing system, comprising: a database, for storing a data set, wherein the data set comprises a plurality of data points; and a processing circuit, coupled to the database, configured to obtain the data set and cluster the data set to generate a plurality of data groups by using a clustering method; wherein processing circuit is configured to select data groups with the fewest number of data points among the plurality of data groups, determine a local most possible outlier of the data group for each data group with the fewest number of data points, and determine a most possible outlier from the local most possible outliers of the data groups with the fewest number of data points according to a center of a data body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data processing system according to an embodiment of the present invention.

FIG. 2 is a flow diagram of a procedure according to an embodiment of the present invention.

FIG. 3 is a schematic diagram of a data set according to an embodiment of the present invention.

FIG. 4 is a schematic diagram illustrating the data clustering according to an embodiment of the present invention.

FIG. 5 is a schematic diagram illustrating the possible outlier distribution according to an embodiment of the present invention.

FIG. 6 is a schematic diagram illustrating the local most possible outlier distribution according to an embodiment of the present invention.

FIG. 7 is a schematic diagram illustrating a most possible outlier according to an embodiment of the present invention.

FIG. 8 is a schematic diagram of a data set according to an alternative embodiment of the present invention.

FIG. 9 is a schematic diagram illustrating the data clustering and the possible outlier distribution according to an alternative embodiment of the present invention.

FIG. 10 is a schematic diagram illustrating the local most possible outlier distribution and the most possible outlier according to an alternative embodiment of the present invention.

### DETAILED DESCRIPTION

Please refer to FIG. 1, which is a schematic diagram of a data processing system 1 according to an embodiment of the present invention. The data processing system 1 includes a processing circuit 10 and a database 20. The database 20 is utilized for storing data sets. Each data set includes a plurality of data points (data subsets). The processing circuit 10 may access data sets stored in the database 20. The processing circuit 10 may also receive and process data sets from external devices.

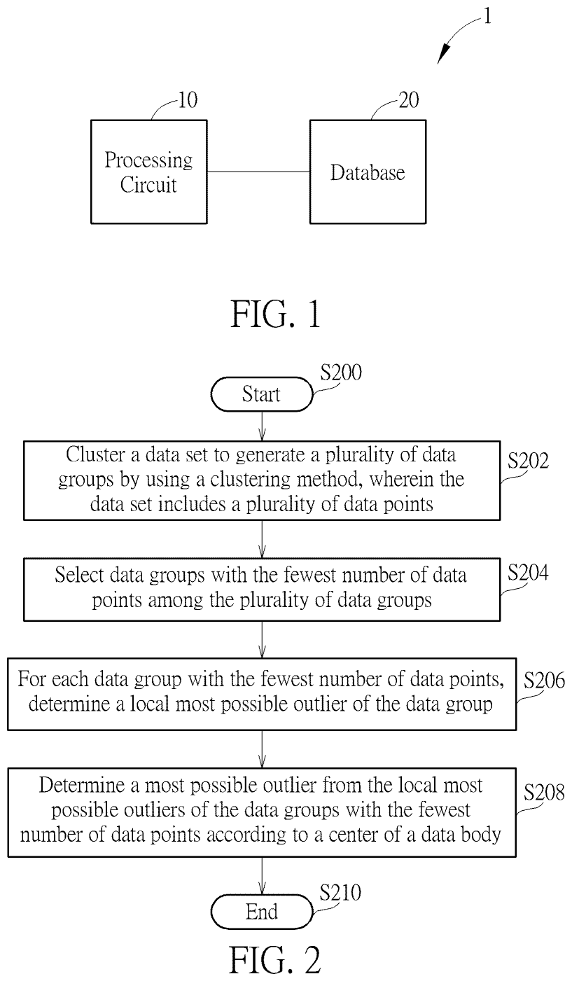

Please refer to FIG. 2. FIG. 2 is a flow diagram of a procedure 2 according to an embodiment of the present invention. The procedure 2 includes the following steps:
Step S200: Start.
Step S202: Cluster a data set to generate a plurality of data groups by using a clustering method, wherein the data set includes a plurality of data points.
Step S204: Select data groups with the fewest number of data points among the plurality of data groups.
Step S206: For each data group with the fewest number of data points, determine a local most possible outlier of the data group.
Step S208: Determine a most possible outlier from the local most possible outliers of the data groups with the fewest number of data points according to a center of a data body.
Step S210: End.

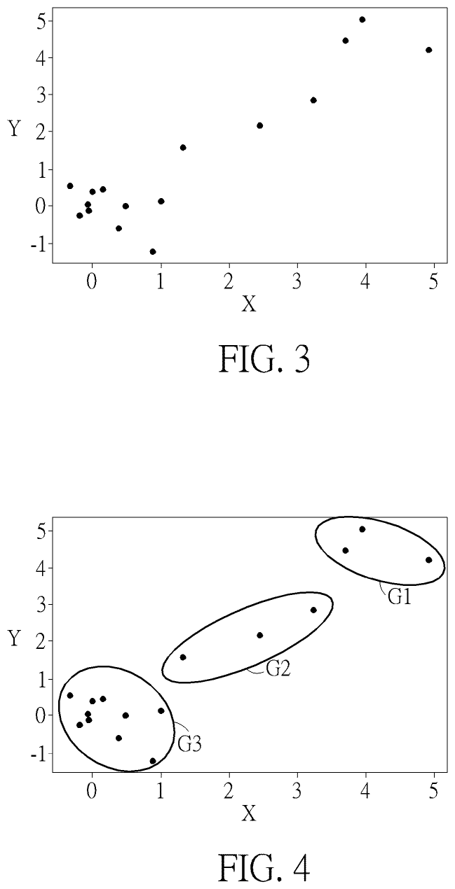

According to the procedure 2, in Step S202, the processing circuit 10 may obtain a data set from the data base 20 or an external device. The data set includes a plurality of data points. For example, please refer to FIG. 3. FIG. 3 is a schematic diagram illustrating a data set according to an embodiment of the present invention. As shown in FIG. 3, the solid circles represent data points. After obtaining the data set, the processing circuit 10 may utilize a clustering method to cluster the data set to generate a plurality of data groups. The data set may be divided into a plurality of data groups based on the grouping method. Each data group includes at least one data point. Please refer to FIG. 4. FIG. 4 is a schematic diagram illustrating the data clustering according to an embodiment of the present invention. As shown in FIG. 4, the data set is clustered and marked into data groups. The plurality of data points in the data set are divided into data groups G1, G2 and G3. The clustering method may be set according to practical requirements. For example, the clustering method may be DBSCAN clustering method, K-means clustering method, agglomerative hierarchical clustering method of machine learning, or any other clustering method.

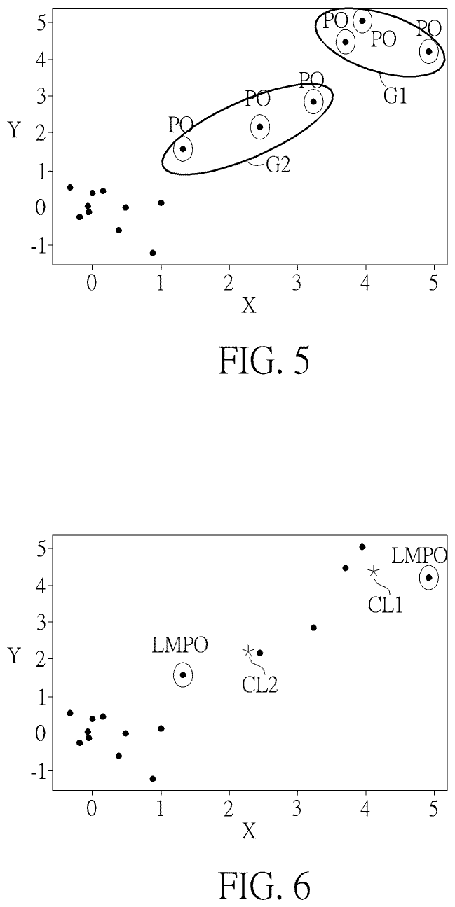

In Step S204, the processing circuit 10 may select data groups with the fewest (minimum) number of data points among the plurality of data groups. Data points in the data group with the fewest number of data points are possible outliers. For example, please refer to FIG. 5. FIG. 5 is a schematic diagram illustrating the possible outlier distribution according to an embodiment of the present invention. As shown in FIG. 4 and FIG. 5, each of the data groups G1 and G2 includes three data points, and the data group G3 includes ten data points. Each of the data groups G1 and G2 has the fewest data points among the data groups G1, G2 and G3. The processing circuit 10 selects the data groups G1 and G2 with the fewest data points. As shown in FIG. 5, all data points of data groups G1 and G2 are possible outliers PO.

In Step S206, for each data group with the fewest number of data points, the processing circuit 10 may determine a local most possible outlier (LMPO) for the data group. For each data group with the fewest number of data points, the processing circuit 10 may determine a center of each data group. The center of the data group may be arithmetic mean, median or mode of all data points in the data group. The center of the data group may be the data point having the minimum summation of distances from other points in the data group. The center of the data group may be one of the data points in the data group. For each data group with the fewest number of data points, the processing circuit 10 may calculate the distance between each data point and the center of the data group. For each data group with the fewest number of data points, the processing circuit 10 may determine a data point that is farthest from the center of the data group, and determine the data point farthest from the center of the data group as a local most possible outlier LMPO of the data group.

Please refer to FIG. 6. FIG. 6 is a schematic diagram illustrating the distribution of the local most possible outlier according to an embodiment of the present invention. As shown in FIG. 6, for the data groups G1, the processing circuit 10 determines that the center of the data group G1 is CL1. The processing circuit 10 calculates the distance between each data point in the data group G1 (i.e., each possible outliers PO in the data group G1 shown in FIG. 5) and the center CL1. A data point that is farthest from the center CL1 in the data group G1 may be determined as a local most possible outlier LMPO for the data groups G1. Similarly, for the data groups G2, the processing circuit 10 determines that the center of the data group G2 is CL2. The processing circuit 10 calculates the distance between each data point in the data group G2 (i.e., each possible outliers PO in the data group G2 shown in FIG. 5) and the center CL2. A data point that is farthest from the center CL23 in the data group G2 may be determined as a local most possible outlier LMPO for the data groups G2 by the processing circuit 10.

Embodiments of the present invention may utilize any distance metric to calculate the distance. For example, the distance metric may be Euclidean distance, a distance metric derived from Lp norm (∥x−y∥p, 1≤p≤∞), or other distance metrics, but not limited thereto. For example, any distance metric that satisfies the following three conditions may be used in the procedure 2 of the embodiments:
1. For any two data points x and y, d(x,y)≥0, and d(x,y)=0⇔x=y;
2. For any two data points x and y, d(x,y)=d(y,x);
3. For any three data points x, y and z, d(x,y)+d(y,z)≥d(x,z)

[symbol]

(1)
where d( ) represents a metric function, x, y, z are data points of the data set.

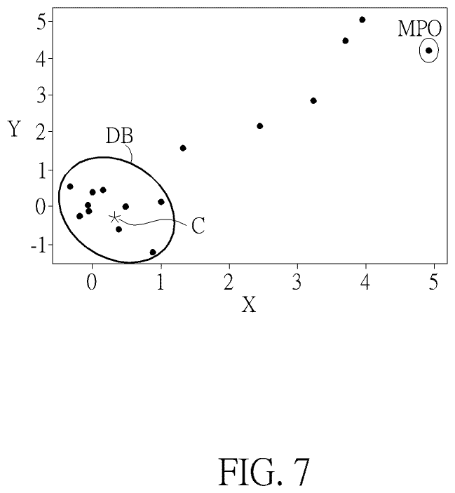

In Step S208, the processing circuit 10 may determine a most possible outlier from the local most possible outliers of the data groups with the fewest number of data points according to a center of a data body. The processing circuit 10 may determine the data body. The data body may include at least one data point of the data set. For example, the data body may include data points within the area having more data points with concentrated distribution in the data set. The data body may include all data points in the data set except possible outliers. That is, the data body may include all the data points that are not possible outliers in the data set. The data body may include the data group with the largest amount of data (data points). The processing circuit 10 may set the data body according to different practical requirements. Moreover, the processing circuit 10 may determine a center of the data body. The center of the data body may be arithmetic mean, median or mode of all data points in the data body. The center of the data body may be the data point having the minimum summation of distances from other points in the data body. The center of the data body may be one of the data points in the data body. For example, please refer to FIG. 7. FIG. 7 is a schematic diagram illustrating a most possible outlier according to an embodiment of the present invention. As shown in FIG. 7, the processing circuit 10 determines the data group with the largest amount of data points (e.g., data group G3 in FIG. 4) as a data body DB, and determines a center C of the data subject DB.

In Step S208, the processing circuit 10 may calculate the distance between each local most possible outlier and the center of the data body. The processing circuit 10 may determine a local most possible outlier that is farthest away from the center of the data body. The processing circuit 10 may determine the local most possible outlier farthest from the center of the data body as a most possible outlier of the data set. For example, please further refer FIG. 6 and FIG. 7. The processing circuit 10 calculates the distance between the local most possible outlier LMPO of the data group G1 and the center C of the data body. The processing circuit 10 calculates the distance between the local most possible outlier LMPO of the data group G2 and the center C of the data body. The distance between the local most possible outlier LMPO of the data group G1 and the center C is greater than the distance between the local most possible outlier LMPO of the data group G2 and the center C. Accordingly, the processing circuit 10 determines the local most possible outlier LMPO of the data group G1 as a most possible outlier MPO of the data set. Therefore, the embodiments of the present invention may be capable of providing the accurate and true outlier detection.

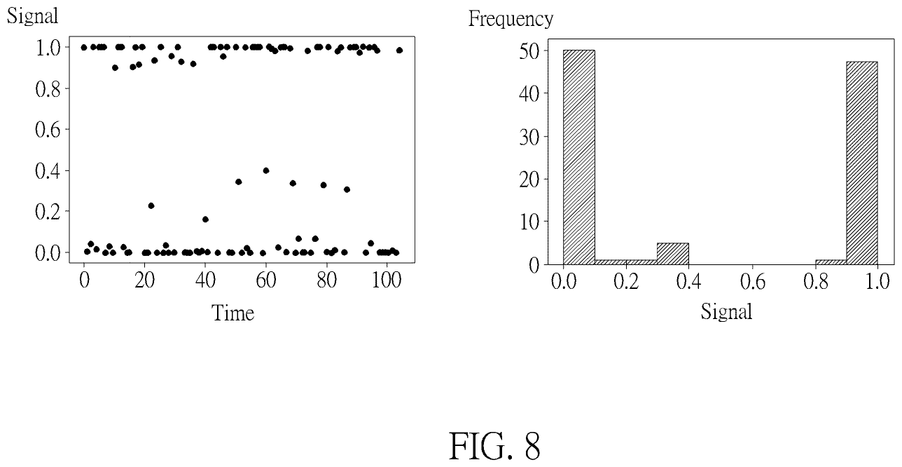

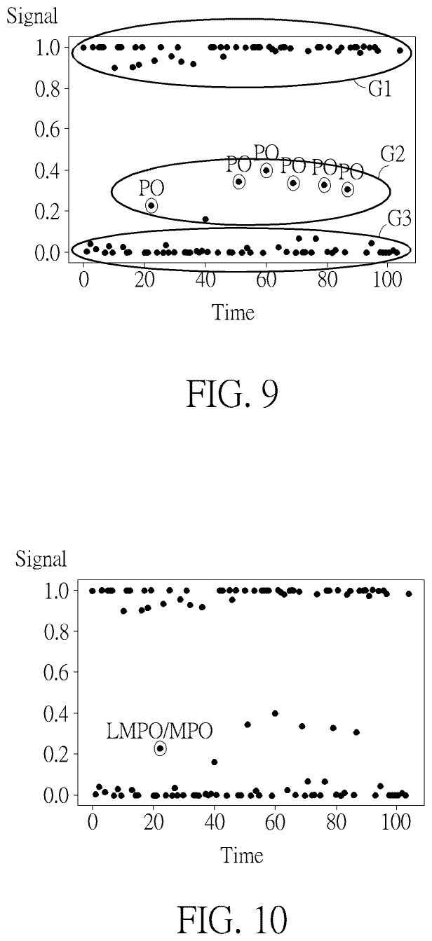

Moreover, the processing circuit 10 may remove the most possible outliers from the data set, so as to perform a data cleaning process. For example, when the data processing system 1 is applied to abnormal current signal detection or digital signal detection, the data value “1” (at first logic level) of the current signal may represent the power-on state, and the data value “0” (at second logic level) may represent the power-off state. The data value determined based on the received signal may be between 0 and 1 due to external interference. As shown in FIG. 8, the data set includes data points associated with the current signal. Most of the data points of the received current signal fall into the value 1 or 0. However, there are still some data points distributed between the value 1 and the value 0 due to the influence of unstable current or power, circuit or signal source interference. As shown in FIG. 9, the processing circuit 10 may divide the plurality of data points of the data set into data groups G1, G2 and G3, and select the data group G2 with the fewest number of data points (Steps S202 and S204). As such, all data points in the data group G2 are possible outliers PO. The data body may be set to include a union of the data value 0 and data value 1 by the processing circuit 10. That is, the data body includes data groups G1 and G3. The processing circuit 10 may define the data value 0 and data value 1 as the centers of the data body. As shown in FIG. 10, the processing circuit 10 may determine a local most possible outlier LMPO of the data group G2, and determine a most possible outlier MPO of the data set. The processing circuit 10 may remove the most possible outlier MPO in the data set to eliminate abnormal current signal for purifying the two-bit signal. Since the data distribution of the current signal usually presents a bimodal state on both sides of the value 0 and the value 1. Most of the outliers determined by the embodiments of the present invention may be far away from the value 0 or the value 1. The above-mention method of the embodiments may be utilized to eliminate abnormal current signals by repeatedly executing the procedure 2, such that the data points of the data set gradually become correct signal data, and the bimodal distribution of signal data becomes more obvious.

For example, regarding the product inspection on the production line, many developing systems have attempted to introduce artificial intelligence models for automatic product inspection. But, the artificial intelligence models need to be trained before being deployed. Production lines with better yield performance usually produce more normal products and produce fewer defective products. If all product data are used for training, a model in which all products are inferred to be normal products may be often obtained. As such, when the data processing system 1 of the embodiments of the present invention is applied to automatic product inspection, the processing circuit 10 may mark all or part of the data points corresponding to normal products as the data body for defective product detection, and perform the defective product marking process after determining the defective products, thus realizing the automatic defective product detection with artificial intelligence. In an alternative embodiment, the procedure 2 of the embodiments may also be applied to identify erroneous data in the database.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, the data processing system 1 or combination thereof. Examples of hardware can include analog, digital and/or mixed circuits known as microcircuit, microchip, or silicon chip. For example, the hardware may include application-specific integrated circuit (ASIC), field programmable gate array (FPGA), programmable logic device, coupled hardware components or combination thereof. In another example, the hardware may include general-purpose processor, microprocessor, controller, digital signal processor (DSP) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. The data processing system 1 of the embodiments of the invention may include the processing circuit 10 and a storage device. Any of the abovementioned procedures and examples above may be compiled into program codes or instructions that are stored in the storage device or a computer-readable medium. The processing circuit 10 may read and execute the program codes or the instructions stored in the storage device or computer-readable medium for realizing the abovementioned functions.

To sum up, the embodiments of the present invention may perform data clustering process on the data set to generate a plurality of data groups, determine the local most possible outliers of the data groups with the fewest number of data points, and determine the most possible outlier from the local most possible outliers of the data groups with the fewest number of data points according to the center of the data body. Therefore, the embodiments of the present invention may provide the accurate and true outlier detection for data set.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method, comprising:
clustering a data set to generate a plurality of data groups by using a clustering method, wherein the data set comprises a plurality of data points;
selecting data groups with the fewest number of data points among the plurality of data groups;
for each data group with the fewest number of data points, determining a local most possible outlier of the data group; and
determining a most possible outlier from the local most possible outliers of the data groups with the fewest number of data points according to a center of a data body.

2. The data processing method of claim 1, further comprising:
for each data group with the fewest number of data points, determining a center of the data group and calculating distances between each data point of the data group and the center of the data group; and
determining a data point that is farthest from the center of the data group and determining the data point farthest from the center of the data group as the local most possible outlier of the data group.

3. The data processing method of claim 1, further comprising:
for each local most possible outlier of the data group with the fewest number of data points, calculating a distance between the local most possible outlier and the center of the data body; and
determining a local most possible outlier that is farthest from the center of the data body and determining the local most possible outlier farthest from the center of the data body as the most possible outlier of the data set.

4. The data processing method of claim 1, wherein the plurality of data points of the data set are data points associated with current signals, and the data body comprises data points with current signals corresponding to a first logic level and data points with current signals corresponding to a second logic level.

5. The data processing method of claim 1, further comprising:
removing the most possible outliers from the data set to perform a data cleaning process.

6. A data processing system, comprising:
a database, for storing a data set, wherein the data set comprises a plurality of data points; and
a processing circuit, coupled to the database, configured to obtain the data set and cluster the data set to generate a plurality of data groups by using a clustering method;
wherein processing circuit is configured to select data groups with the fewest number of data points among the plurality of data groups, determine a local most possible outlier of the data group for each data group with the fewest number of data points, and determine a most possible outlier from the local most possible outliers of the data groups with the fewest number of data points according to a center of a data body.

7. The data processing system of claim 6, wherein for each data group with the fewest number of data points, the processing circuit is configured to determine a center of the data group and calculate distances between each data point of the data group and the center of the data group, and the processing circuit is configured to determine a data point that is farthest from the center of the data group and determine the data point farthest from the center of the data group as the local most possible outlier of the data group.

8. The data processing system of claim 6, wherein for each local most possible outlier of the data group with the fewest number of data points, the processing circuit is configured to calculate a distance between the local most possible outlier and the center of the data body, and the processing circuit is configured to determine a local most possible outlier that is farthest from the center of the data body and determine the local most possible outlier farthest from the center of the data body as the most possible outlier of the data set.

9. The data processing system of claim 6, wherein the plurality of data points of the data set are data points associated with current signals, and the data body comprises data points with current signals corresponding to a first logic level and data points with current signals corresponding to a second logic level.

10. The data processing system of claim 6, wherein the processing circuit is configured to remove the most possible outliers from the data set to perform a data cleaning process.
